(19) United States
(12) Patent Application Publication
(10) Pub. No.: US 2005/0126632 A1
(43) Pub. Date: Jun. 16, 2005

(54) Beverage modification system

(76) Inventors: Steven Handling Farrell, Cincinnati, OH (US); Kathleen Mary Elsen, Cleves, OH (US); Robert Leslie Swaine JR., Glendale, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/733,826

(22) Filed: Dec. 11, 2003

(51) Int. Cl. A21D 10/02

(52) U.S. Cl. 137/155

(57) ABSTRACT

A beverage modification system having a container, a cap, a pouch and a pouch opener. A modification composition is contained within the pouch. The cap, containing the pouch, is secured onto the opening of a container containing a fruit-flavored liquid beverage composition. When the pouch opener is activated, the modification composition is released from the pouch and mixes with the liquid beverage composition to modify the color and flavor of the liquid beverage, resulting in a modified beverage composition.

### TECHNICAL FIELD

The present invention relates to beverage modification systems comprising a modification composition, which is preferably in liquid or powder form, contained within a cap that is attached to a container that preferably contains a fruit-flavored liquid beverage composition. After the cap is attached, the modification composition may be released from the cap, allowing the modification composition to mix with, and modify, the liquid beverage composition. The resulting modified beverage composition, which contains the modification composition, has a different color and flavor than the liquid beverage composition.

### BACKGROUND OF THE INVENTION

Two-thirds of the human body is composed of water. Water is an essential nutrient that is necessary to maintain the proper functioning of the body. Specifically, the human brain is about 85% water and our bones are between 10 to 50% water. Moreover, water helps with the transportation of nutrients, and moving waste into and out of cells, as well as aiding digestion, absorption, circulation and maintaining body temperature.

Water must be continuously replaced since, on average, 250 ml is lost on a daily basis through breathing alone. It is difficult to predict an exact daily requirement because the amount of water required will vary depending on the on the climate and whether any type of activity is undertaken. Regardless, it is important to drink an adequate amount of water each day-at least eight glasses (2 liters)—to maintain good bodily health.

The best way to obtain the water your body needs is by drinking plain water. However, other beverages, such as fruit juices, milk, and non-caffeinated drinks are also excellent sources of water. Therefore, because there is a need to constantly replenish the human body with water in its various forms, there is also a need to continuously develop new and exciting beverages that appeal to consumers, thus making the task of attaining your daily water needs a more pleasant and enjoyable experience.

In today's market of savvy consumers, an emphasis is placed on providing choices. Consumers enjoy having the ability to individualize the products they use to meet their specific needs. Additionally, consumers seek out products that are thrilling and unique. Most beverages today provide consumers with little choice. Beverages are generally marketed as either a prepackaged liquid, to be consumed ‘as is,’ or as powdered or concentrated beverage mix to be added to water or milk, such as Kool-Aide®, hot chocolate or instant coffee. Thus, achieving daily hydration goals often becomes routine and tedious. Therefore, there is a need to provide new beverage options that are fun, quick, exciting and offer consumers a choice.

The present invention seeks to satisfy all of the foregoing consumer needs by allowing the consumer to choose between a fruit-flavored liquid beverage composition present in the container as packaged, and a modified beverage composition having a color and flavor that are distinctly different from the packaged liquid beverage. The modification of the liquid beverage is marked by a dramatic color change in the beverage, which is pleasing and enjoyable to consumers. In this way, the present invention provides the consumer with the fun, excitement and choice that is desired when selecting products to meet their hydration needs. Additionally, the present invention will drives sales in the competitive beverage industry by offering consumers a new and thrilling option, unlike any product currently on the market.

### SUMMARY OF THE INVENTION

One aspect of the present invention provides for a beverage modification system comprising:
A beverage modification system comprising:
   a) a container containing a fruit-flavored liquid beverage composition;
   b) a cap comprising a pouch and a pouch opener; and
   c) a modification composition retained by the pouch.

Further, when the cap is removably secured onto the opening of a container, which contains a fruit-flavored liquid beverage composition, and when the pouch opener is activated, the modification composition is released from the pouch and mixes with the liquid beverage to produce a modified beverage composition having a different color and different flavor than the liquid beverage composition. It is preferred that both the fruit-flavored liquid beverage and the modified beverage are cloudy in appearance, so as to make the color change a more dramatic experience. The modification composition and or the liquid beverage may contain water, coloring and flavoring agents, preservatives, sweeteners, vitamins, minerals, effervescence, and the like.

In another aspect of the present invention there is provided a beverage modification system comprising a cap comprising a pouch and a pouch opener wherein the pouch opener comprises a blade that cuts into and opens the pouch when the cap is twisted onto a container. In another aspect, the pouch opener comprises a plunger that opens the pouch when it is pressed down and through the pouch. Preferably, the cap further comprises a removable retaining ring that protects the pouch from being opened prematurely.

The beverage modification composition generally comprises coloring agents and flavoring agents and may be in the form of a powder, liquid, tablet, or the like, although a powder or liquid is preferred. Depending on the formulation of the modification composition and the liquid beverage utilized, the resulting modified beverage compositions may be a variety of colors and flavors. The present invention allows the consumer to choose the color and flavor of the beverage by providing a choice between consuming the fruit-flavored liquid beverage as packaged, and adding the modification composition to produce a modified beverage having both a different color and flavor.

Additionally, it is preferred that the cap portion of the present invention is compatible with a common container, such as a juice, water or milk bottle, allowing the consumer to combine the beverage modification powder with a preexisting bottle of liquid beverage. Moreover, it is preferred that the container, liquid and modification composition are sold together but unmixed so that the consumer may mix a fresh composition when they so desire. Furthermore, the liquid beverage compositions used in the present beverage modification system are preferably fruit-flavored, either artificially, naturally or both, although any suitable liquid will suffice. Moreover, the liquid beverage compositions are preferably cloudy in appearance, so as to make the color change a more dramatic experience. It is desired that the color and flavor of the modified beverage is distinctly different from the liquid beverage present prior to the addition of the modification composition.

### BRIEF DESCRIPTION OF THE DRAWINGS

While the present invention is defined by the claims herein, it is believed that these claims will be better understood with reference to the drawings wherein:

FIG. 1 is a beverage modification system according to the present invention comprising a cap with a plunger style opening mechanism;

FIG. 2 is a beverage modification system similar to the one shown in FIG. 1 before the pouch is punctured;

FIG. 3 is a pouch containing a beverage modification composition according to the present invention;

FIG. 4 is a beverage modification system according to the present invention comprising a cap with a screw-in-blade type opener;

FIG. 5 is the beverage modification system of FIG. 4 after the pouch has been cut open;

FIG. 6 is a beverage modification system according to the present invention comprising a cap wherein the pouch opener is adjacent the bottle rim;

FIG. 7 is the beverage modification system of FIG. 6 after the pouch has been cut open;

FIG. 8 is a beverage modification system according to the present invention comprising a cap wherein the pouch is a single layer barrier and the beverage modification composition is contained within a hollow plunger that acts as the pouch opener;

FIG. 9 is a top view of the beverage modification system of FIG. 8 showing the protective cap that keeps the plunger from being prematurely depressed;

FIG. 10 is a beverage modification system according to the present invention comprising a cap wherein the beverage modification composition is contained within a plunger and the plunger bottom seals and protects the modification composition from the liquid below; and

FIG. 11 is the beverage modification system of FIG. 10 showing the beverage modification composition being released from the pouch within the cap as the plunger mechanism is depressed and the side openings of the plunger are exposed.

### DETAILED DESCRIPTION OF THE INVENTION

As used herein, the term “comprising” means various components conjointly employed in the preparation of the liquid compositions of the present invention. Accordingly, the terms “consisting essentially of” and “consisting of” are embodied in the term “comprising.”

As used herein, the term “cloudy” describes a liquid that is not transparent. The distinction between transparent and cloudy beverages will be obvious to those of ordinary skill in the art.

As used herein, the term “fruit-flavored liquid beverage composition” means a drinkable beverage containing from about 0.1% to about 40% natural fruit juice, artificial fruit flavoring, concentrates thereof or mixtures thereof. Suitable natural or artificial fruit flavors include, but are not limited to, lemon, orange, grapefruit, strawberry, banana, pear, kiwi, grape, apple, lemon, mango, pineapple, passion fruit, raspberry and mixtures thereof.

As used herein, the term “pouch” means either a single or double-layered membrane that is used to retain the modification composition and keep it isolated from the liquid beverage. If a single-layered membrane is used, the membrane acts a wall between the modification composition, and the liquid beverage. If a double-layered membrane is used, the modification composition is housed in a space between the sealed membrane layers, and thus, isolated from the liquid beverage.

As used herein, all parts, percentages and ratios are based on weight unless otherwise specified.

Beverage Modification System

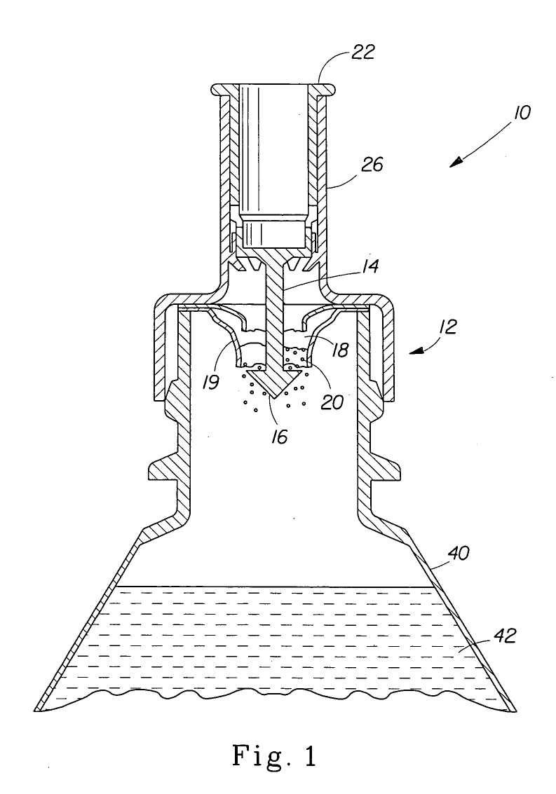

Turning now to the drawings wherein FIG. 1 is a beverage modification system 10 according to the present invention, which comprises cap 12 with plunger 14. Plunger 14 comprises barb 16, is adjacent plunger detent 22, and is slideably housed within cap housing 26. In FIG. 1, cap 12 is shown on container 40 that contains a fruit-flavored liquid beverage composition 42. Plunger detent 22 has been depressed by a consumer by, for example, pushing plunger 14 and plunger barb 16 through pouch membrane 19, which opens pouch 18 releasing modification composition 20. Modification composition 20 comprises, among other ingredients, coloring agents and flavoring agents, which are discussed in greater detail below. Modification composition 20 may also contain the various optional ingredients discussed below. As shown in FIG. 1, when pouch 18 is opened and the modification composition 20 is released, modification composition 20 will fall into liquid beverage composition 42 where it may be mixed by slight agitation (for example, shaking of the container by a consumer) to alter the color and flavor of the liquid composition. Liquid beverage composition 42 may be any liquid suitable for consumption by mammals, although liquid beverages having a natural of artificial fruit flavor are preferred.

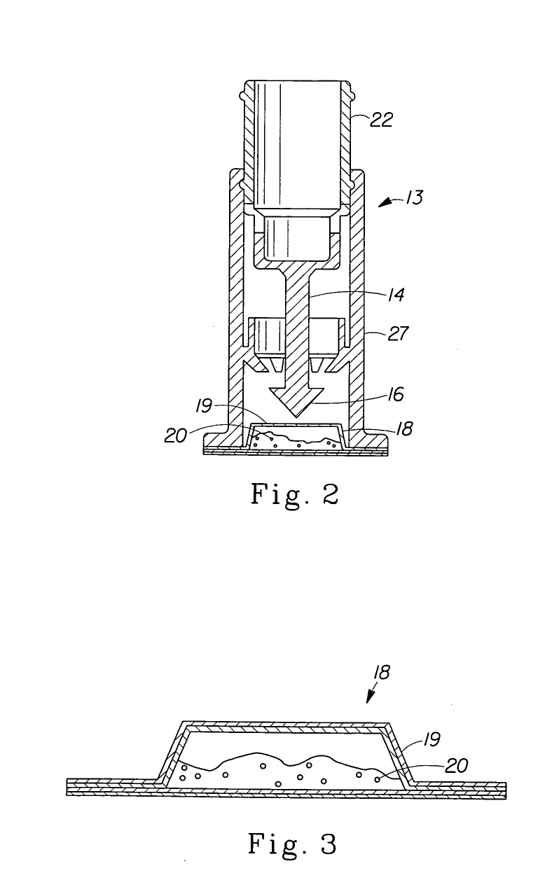

FIG. 2 is a beverage modification system similar to that of FIG. 1 before the pouch is punctured. Note that in FIG. 2, cap housing 27 of cap 13 is designed to sit on top of a container rather than sealing the container top by enclosing its neck. Cap 13 provides a beverage modification system that may modify a liquid beverage in a variety of containers because it is not constrained to any one container neck design or other enclosure devices associated therewith. Moreover, pouch 18 is shown in FIG. 2 as being attached to cap 13, but this need not be the case.

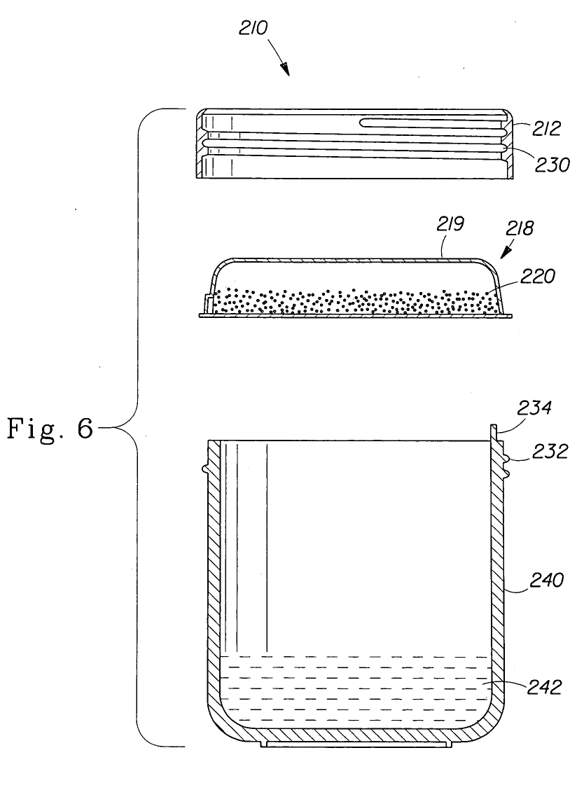

FIG. 3 shows a pouch 18 containing beverage modification composition 20. As can be seen, pouch 18 may be a self contained, free-standing unit that may be associated with or attached to either of cap 13 or container 40. Likewise, as shown in FIG. 6, pouch 218 may be associated with neither cap 212 nor container 240, but is rather placed between the cap 212 and the container 240 at the time of use.

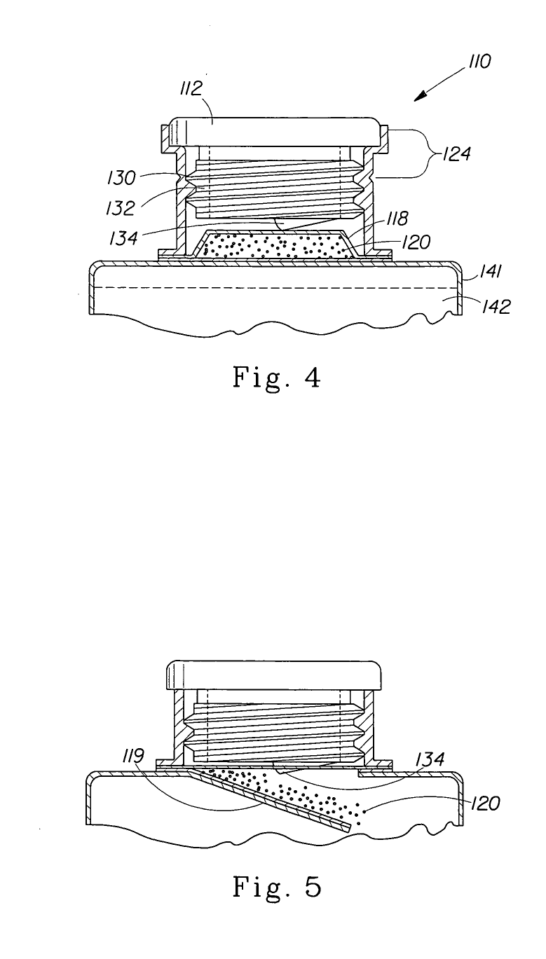

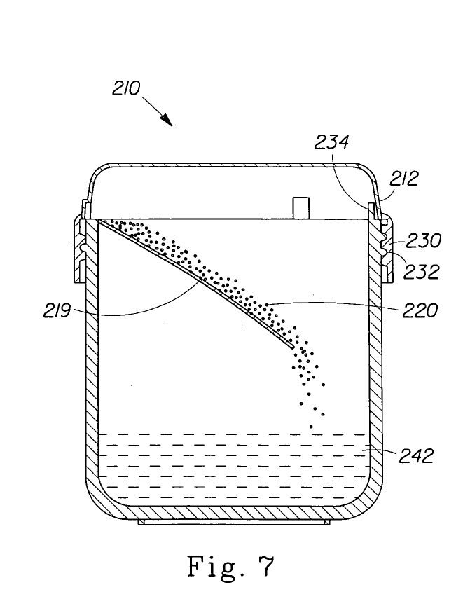

FIG. 4 shows yet another beverage modification system 110 according to the present invention comprising cap 112 with a blade 134 that cuts into pouch 118 when cap 112 is screwed onto container 141, via cap threads 130 and package threads 132. Blade 134 is associated with cap 112 but could easily be associated with the container as shown in FIGS. 6 and 7, wherein blade 234 is on container 240. Returning to FIGS. 4 and 5, container 141 may be a bottle, ajar, a juice box or any other appropriate container for a liquid beverage. FIG. 5 illustrates the modification system of FIG. 4 after pouch membrane 119 has been cut open by blade 134, dispensing modification composition 120 into liquid beverage 142 to produce the desired color and flavor change.

Removable retaining ring 124, shown in FIG. 4, is used to ensure that pouch 118 cannot be opened prematurely. It is understood that one of the purposes of the present invention is to allow the consumer to mix, that is prepare, the modified beverage whenever he or she wishes. It can be seen that blade 134 does not penetrate pouch membrane 119 when cap 112 is first screwed onto container 141. Rather, cap 112 is screwed partially into container 141 with no contact between blade 134 and pouch membrane 119. Retaining ring 124 locks cap 112 into this pre-cutting position. Retaining ring 124 may be easily removed by pulling a tab or breaking a seal, and then removing the ring. Once retaining ring 124 is removed, cap 112 is further screwed onto container 141 allowing blade 134 to cut into pouch membrane 119 opening pouch 118. Thus, to insure that cap 112 is not screwed into package 141 before the consumer wants it to be, retaining ring 124 is removably attached to cap 112. Retaining rings are, of course, optional for the beverage modification systems of the present invention, but they may be used with any of the embodiments shown herein.

As mentioned briefly above, FIGS. 6 and 7 illustrate a beverage modification system 210 according to the present invention comprising cap 212 wherein blade 234 is adjacent container 240. Moreover, pouch 218, comprising pouch membrane 219 and beverage modification composition 220, is separate from container 240 and cap 212. As such, pouch 218 may be sold and shipped separately from cap 212, container 240 and liquid beverage 242. Thus, pouch 218 may be placed on the open container 240 and cap 212 screwed onto container 240 via cap threads 230 and container threads 232. At some point before cap 212 is fully screwed onto container 240, blade 234 contacts and cuts pouch membrane 219 releasing modification composition 220 into liquid beverage 242 as shown in FIG. 7.

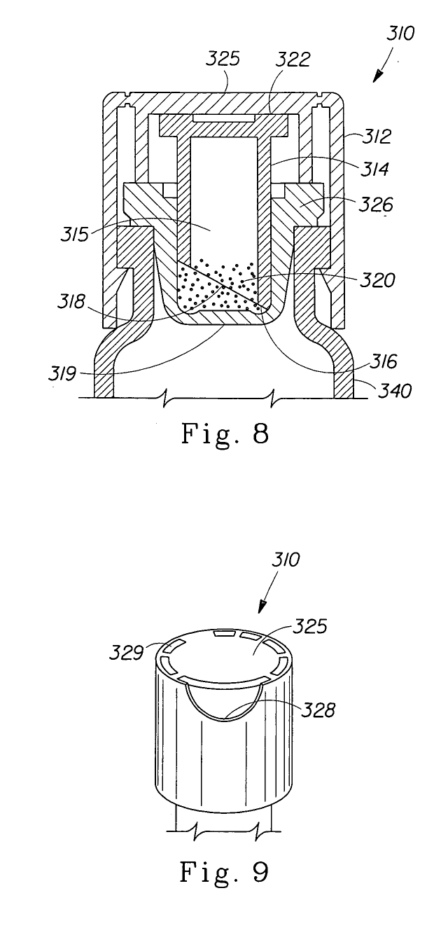

Turning now to FIG. 8, which shows beverage modification system 310 according to the present invention comprising cap 312 with plunger 314. Plunger 314 comprises plunger barb 316, plunger detent 322, and is slideably housed within cap housing 326. Further, plunger 314 comprises plunger hollow core 315 that may contain modification composition 320. In FIG. 8, cap 312 is shown on container 340. When plunger detent 322 is depressed by the consumer (not shown), plunger 314 and plunger barb 316 are pushed through pouch membrane 319, which opens pouch 318 releasing modification composition 320. In this embodiment pouch 318 comprises a single layer pouch membrane 319 and plunger hollow core 315. Modification composition 320 comprises, among other ingredients, coloring agents and flavoring agents, which are discussed in greater detail below. Modification composition 320 may also contain the various optional ingredients discussed below.

Beverage modification system 310 further comprises removable retaining cap 312 that protects plunger 314 from being depressed prematurely. FIG. 9 is a top view of beverage modification system 310 showing removable retaining cap 312, retaining cap perforations 329 and retaining cap access 328. Retaining cap 325 may be removed by sticking an available implement, such as a finger tip, car key, etc., into retaining cap access 328, and applying an upward force sufficient to tear perforation 329. Once retaining cap 325 has been removed, plunger detent 322 may be pushed down causing plunger barb 316 to pierce and open pouch membrane 319 releasing modification composition 320.

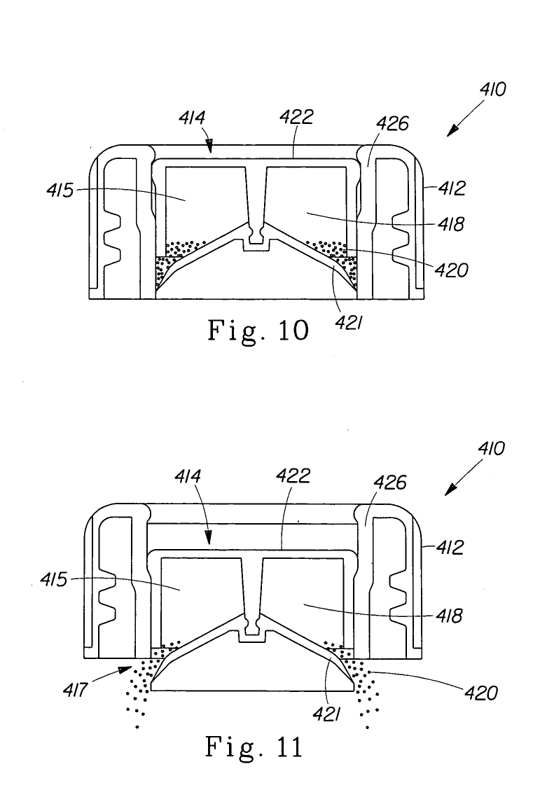

Turning now to FIG. 10, which shows yet another embodiment of the present invention, specifically, beverage modification system 410 comprising cap 412 with plunger 414. Plunger 414 comprises plunger detent 422 and pouch seal 421, and is slideably housed within cap housing 426. Further, plunger 414 comprises plunger hollow core 415 that may contain beverage modification composition 420. When plunger detent 422 is depressed by the consumer (not shown), plunger 414 and pouch seal 421 slide within cap housing 426 allowing the hollow, core edges 417 of plunger hollow core 415 to be exposed as pouch seal 421 is pushed beyond cap housing 426 as shown in FIG. 11. When plunger hollow core edges 417 are exposed, pouch 418 is opened releasing modification composition 420. Modification composition 420 comprises, among other ingredients, coloring agents and flavoring agents, which are discussed in greater detail below. Modification composition 420 may also contain various optional ingredients discussed below.

The various components of the present systems, for example, caps, containers, blades and plungers may be made from any of a variety of commonly available materials such as, plastic, glass, metal, paper, and laminates of these. The pouch membranes should be made of a material that is readily opened by the blade or plunger used to open the pouch. Moreover, the pouch membrane should not adversely affect the liquid beverage after it is opened. For example, a glass pouch might be inappropriate for use herein if it breaks in a manner that leaves glass shards in the liquid beverage. If, however, a portion of the pouch is made of glass and this portion remains intact after a different portion of the pouch membrane is cut, then there would be no contamination of the liquid beverage. This design, and many more that involve combinations of various materials, would be appropriate for use in the present invention. For a more detailed description of the component parts for use in the present system please see the following U.S. patent: U.S. Pat. No. 6,105,760, which issued to Mollstam et al. on Aug. 22, 2000; U.S. Pat. No. 6,098,795, which issued to Mollstam et al. on Aug. 8, 2000; U.S. Pat. No. 6,209,718, which issued to Mollstam et al. on Apr. 3, 2001; U.S. Pat. No. 5,884,759, which issued to Gueret on Mar. 23, 1999; U.S. Pat. No. 5,419,429, which issued to Zimmerman et al. on May 30, 1995, and U.S. Pat. No. 5,370,222, which issued to Steigerwald et al. on Dec. 6, 1994. The disclosures of the Mollstam et al., Gueret, Zimmerman et al., and Steigerwald et al. references are incorporated herein in their entirety by reference.

The Beverage Modification System

As discussed above, the present beverage modification system houses a liquid beverage composition and a modification composition. The liquid beverage composition is present in the container as packaged, while the modification composition is separated from the liquid beverage by a single or double-layered membrane, or pouch. The pouch is preferably located within the cap of the container, but may be located in any suitable position. When the pouch membrane is broken or opened by the pouch opener, the modification composition, which is water-dispersible, is released into the liquid beverage, thereby dramatically changing the color and flavor of the liquid beverage.

In order to achieve the desired color/flavor change effect, both the liquid beverage and the modification composition may comprise a combination of the following ingredients. Most of these ingredients may be included in the liquid beverage and/or the modification composition of the present beverage modification system.

The liquid beverage of the present invention is preferably a fruit-flavored, liquid beverage having a cloudy appearance. The liquid beverage is present in the container portion of the present invention, as packaged. While the liquid beverage may include any of the following ingredients, it is preferred that the liquid beverage composition generally consist of at least water flavoring agents, emulsifiers, preservatives, coloring agents, and sweeteners.

Similarly, the modification composition may include most of the following ingredients, which are separated from the liquid beverage by a single or double-layered pouch membrane preferably housed within the cap portion of the container. While the modification composition may include most of the following ingredients, it is preferred that the modification composition generally consists of at least coloring agents and flavoring agents.

Ingredients for Liquid Beverage and Modification Composition

Water

Water is one possible constituent of the present liquid beverage and modification compositions. In the liquid beverage composition, water is preferably present in an amount of at least about 20%, more preferably at least about 40%, still more preferably at least about 50%, even more preferably at least about 75%, and most preferably at least about 80%, by weight of the liquid beverage composition. Still further, the liquid beverage compositions will typically comprise from at least about 80% to about 90% water, by weight of the liquid beverage composition.

Likewise, if water is included in the modification composition, it is preferably present in an amount of at least about 10%, preferably from about 15% to about 60%, more preferably from about 20% to about 40%, and still more preferably from about 30% to about 35%, by weight of the modification composition.

The water included at these levels includes all added water and any water present in combination components, such as, for example, fruit juice.

Flavoring Agent

One or more flavoring agents may be incorporated into the present liquid beverage and modification compositions. These flavoring agents may comprise natural fruit juice, artificial fruit-flavoring, or mixtures thereof. Suitable flavoring agents for use in the present invention include but are not limited to, lemon, orange, grapefruit, strawberry, banana, pear, kiwi, grape, apple, lemon, mango, pineapple, passion fruit, raspberry and mixtures thereof.

When present in the liquid beverage, the flavoring agents account for about 0.01% to about 5%, preferably from about 0.5% to about 4%, and more preferably from about 0.5% to about 3%, of the liquid beverage, by weight of the liquid beverage.

Similarly, when included in the modification composition, the flavoring agents are present in an amount of about 1% to about 15%, preferably from about 2% to about 12%, more preferably from about 2% to about 10%, and still more preferably from about 3% to about 8%, by height of the modification composition

Emulsifiers and Oils

One or more emulsifiers and/or oils may also be included in the present liquid beverage. Typical emulsifiers and oils useful herein include, for example, mono- and di-glycerides, lecithin, pulp, cotton seed oil, and vegetable oil. Wherein emulsifiers are included in the present liquid beverage, the compositions typically contains from about 0.001 to about 0.5%, preferably from about 0.02% to about 0.1%, more preferably from about 0.02% to about 0.08%, still more preferably from about 0.03% to about 0.04%, by weight of the liquid beverage.

Preservatives

Optionally, one or more preservatives may be utilized in the liquid beverage and modification compositions herein. Preferred preservatives include, for example, sorbate, benzoate, and polyphosphate preservatives.

Preferably, wherein a preservative is utilized herein, one or more sorbate or benzoate preservatives (or mixtures thereof) are utilized. Sorbate and benzoate preservatives suitable for use in the present invention include sorbic acid, benzoic acid, and salts thereof, including (but not limited to) calcium sorbate, sodium sorbate, potassium sorbate, calcium benzoate, sodium benzoate, potassium benzoate, and mixtures thereof.

Wherein the liquid beverage comprises a preservative, the preservative is preferably included at levels from about 0.0005% to about 0.5%, more preferably from about 0.001% to about 0.4% of the preservative, still more preferably from about 0.001% to about 0.2%, and most preferably from about 0.001% to about 0.1% by weight of the liquid beverage.

Wherein the modification composition comprises a preservative, the preservative is preferably included at levels of from about 0.001% to about 50%, preferably from about 0.1% to about 40%, more preferably from about 1% to about 30%, still more preferably from about 5% to about 20%, and most preferably from about 5% to about 15%, by weight of the modification composition.

Wherein the liquid beverage or modification composition comprises a mixture of one or more preservatives, the total concentration of such preservatives is preferably maintained within these ranges.

Coloring Agent

Small amounts of coloring agents, such as the FD&C dyes (e.g. yellow #5, blue #2, red #40) and/or FD&C lakes may be used in the present liquid beverage and modification compositions. Such coloring agents may be added to create a dramatic opaque color or a drastic color change. By adding the lakes to the other composition ingredients, all particles are completely and uniformly colored and a uniformly colored beverage may be attained. Preferred lake dyes that may be used in the present invention are the FDA approved Lake, such as Lake red #40, yellow #6, blue #1, and the like. Additionally, a mixture of FD&C dyes or a FD&C lake dye in combination with other conventional food and food colorants may be used. The exact amount of coloring agent used will vary, depending on the agents used and the intensity desired in the finished product. The amount may be readily determined by one skilled in the art.

Generally the coloring agent should be present in the liquid beverage at a level of at least about 0.002%, preferably from about 0.002% to about 0.1%, more preferably from about 0.004% to about 0.01%, still more preferably about 0.007%, by weight of the liquid beverage.

Similarly, in the modification composition, the coloring agent should be present at a level of from about 0.1% to about 4%, preferably from about 0.1% to about 2.5%, more preferably from about 1% to about 2%, by weight of the modification composition.

Sweetener

The liquid beverage and modification compositions of the present invention may optionally comprise a sweetener. Suitable particulate sugars may be granulated or powdered, and may include, but are not limited to, sucrose, fructose, dextrose, maltose, lactose and mixtures thereof. Most preferred is sucrose. Artificial sweeteners may also be used. Mixtures of sugars and artificial sweeteners may be used.

In addition, other natural or artificial sweeteners may also be incorporated therein. Other suitable sweeteners include, but are not limited to, saccharin, cyclamates, acesulfwn-K, L-aspartyl-L-phenylaianine lower alkyl ester sweeteners (e.g. aspartame), L-aspartyl-Dalanine amides disclosed in U.S. Pat. No. 4,411,925 to Brennan et al., L-aspartyl-D-serine amides disclosed in U.S. Pat. No. 4,399,163 to Brennan et al., L-aspartyl-L-1-hydroxymethylalkaneamide sweeteners disclosed in U.S. Pat. No. 4,338,346 to Brand, L-aspartyl-1-hydroxyethyalkaneamide sweeteners disclosed in U.S. Pat. No. 4,423,029 to Rizzi, L--aspartyl-D-phenylglycine ester and amide sweeteners disclosed in European Patent Application 168,112 to J. M. Janusz, published Jan. 15, 1986, and the like.

It is preferred that the sweeteners are present in the liquid beverages at a level of at least about 1%, preferably from about 5% to about 25%, more preferably from about 10% to about 20%, still more preferably from about 14% to about 18%, by weight of the liquid beverage or modification composition.

When present in the modification composition, the sweetener is preferably present at a level of at least about 5%, preferably from about 5% to about 90%, more preferably from about 20% to about 85%, and still more preferably from about 30% to about 80%, by weight of the modification composition.

Moreover, in the powdered modification composition, the ‘sweetener’ may also serve as a carrier. For example, the main purpose of including sucrose in the powdered modification composition is to aid in the transport of the remaining ingredients, rather than enhance the sweetness of the composition. It will be obvious to one skilled in the art the purpose(s) the sweetener is to serve.

Nutrients

The liquid beverage and modification compositions herein may optionally be fortified further with one or more nutrients, especially one or more vitamins and/or minerals. The U.S. Recommended Daily Intake (USRDI) for vitamins and minerals are defined and set forth in the Recommended Daily Dietary Allowance-Food and Nutrition Board, National Academy of Sciences-National Research Council.

Unless otherwise specified herein, wherein a given mineral is present in the composition, the composition typically comprises at least about 1%, preferably at least about 5%, more preferably from about 10% to about 200%, even more preferably from about 40% to about 150%, and most preferably from about 60% to about 125% of the USRDI of such mineral. Unless otherwise specified herein, wherein a given mineral is present in the composition, the composition comprises at least about 1%, preferably at least about 5%, more preferably from about 10% to about 200%, even more preferably from about 20% to about 150%, and most preferably from about 25% to about 120% of the USRDI of such vitamin.

Non-limiting examples of such further vitamins and minerals, include niacin, thiamin, folic acid, pantothenic acid, biotin, vitamin A, vitamin C, vitamin B₂, vitamin B₃, vitamin B₆, vitamin B₁₂, vitamin D, vitamin E, vitamin K, iron, zinc, copper, phosphorous, iodine, chromium, molybdenum, and fluoride. Preferably, wherein a further vitamin or mineral is utilized the vitamin or mineral is selected from niacin, thiamin, folic acid, iodine, vitamin A, vitamin C, vitamin B₆, vitamin B₁₂, vitamin D, vitamin E, iron, zinc, and calcium. Preferably, at least one vitamin is selected from vitamin C, vitamin B₆, vitamin B₁₂, vitamin E, pantothenic acid, niacin, and biotin. Also preferably, the composition comprises vitamin C and one or more other vitamins selected from vitamin B₆, vitamin B₁₂, vitamin E, pantothenic acid, niacin, biotin.

Effervescence

Additionally, the liquid beverage and modification compositions herein may optionally further comprise effervescence, which provides a temporary foaming or bubbling effect when either the liquid beverage container is initially opened, or when the modification composition is first introduced into the liquid beverage composition. The foaming or bubbling effect is made possible by the incorporation of carbon dioxide into the composition. The amount of carbon dioxide introduced into the beverage will depend upon the particular flavor system utilized and the amount of carbonation desired.

Ratio of Modification Composition to Liquid Beverage

The modified beverage compositions of the present invention preferably have a modification composition to liquid beverage ratio of from about 1:1000 to about 1:10, preferably from about 1:500 to about 1:10, and more preferably from about 1:100 to about 1:10, by weight of the modified beverage composition.

### EXAMPLES

The following are non-limiting examples of modification compositions, as well as liquid beverage compositions, that may be use in the pouch and containers, respectively, of the present beverage modification systems. The modification compositions and liquid beverages are prepared utilizing conventional methods. The following examples are provided to illustrate the invention and are not intended to limit the scope thereof in any manner.

### Example 1

A powdered modification composition is prepared having the following ingredients in the indicated amounts:

| Ingredient | Wt. % |
|---|---|
| Cherry Flavor F96819 (Mane) | 6.23 |
| Red #40 | 1.99 |
| TCP | 2.00 |
| Ethyl Vanillin | 0.07 |
| Zeofree (Huber) | 1.00 |
| Sucrose | 88.71 |

Upon preparing the modification composition, which is a powder, it is placed in a sealed pouch, at 2 grams for every 330 ml of liquid beverage, anal inserted into a cap as shown in FIG. 1. The cap is then placed on a container holding a fruit-flavored liquid beverage. The fruit-flavored liquid beverage is orange in color and flavor, cloudy in appearance, and has the general formula:

| Ingredient | Weight % |
|---|---|
| Water | 83.00% |
| Flavoring Agent (Juice + Artificial Flavoring) | 1.55% |
| Emulsifiers and Oils | 0.03% |
| Preservatives | 0.01% |
| Coloring Agent | 0.01% |
| Sweetener | 15.00% |

The plunger is then depressed, releasing the modification composition into the liquid beverage. The container is gently swirled to mix the powdered modification composition and liquid beverage, resulting in a modified beverage composition that is cloudy, red in color and cherry in flavor.

### Example 2

A liquid modification composition is prepared having the following ingredients in the indicated amounts:

| Ingredient | Wt. % |
|---|---|
| Cherry Flavor F96903 (Mane) | 1.43 |
| Red #40 | 2.09 |
| Ethyl Vanillin | 0.07 |
| Propylene Glycol | 50.00 |
| Distilled Water | 33.00 |
| Ethanol | 13.41 |

Upon preparing the modification composition, which is a liquid, it is placed in a sealed pouch, at 0.75 grams for every 330 ml of liquid, and inserted into a cap as shown in FIG. 1. The cap is then placed on a container holding a fruit-flavored liquid beverage. The fruit-flavored liquid beverage is orange in color and flavor, cloudy in appearance and has the general formula:

| Ingredient | Weight % |
|---|---|
| Water | 83% |
| Flavoring Agent (Juice + Artificial Flavoring) | 1.55% |
| Emulsifiers and Oils | 0.03% |
| Preservatives | 0.01% |
| Coloring Agent | 0.01% |
| Sweetener | 15.00% |

The plunger is depressed and the container is gently swirled to mix the liquid modification composition and liquid beverage. The result is a modified beverage composition that is cloudy, red in color and cherry in flavor.

All documents cited in the Detailed Description are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A beverage modification system comprising:
a) a container containing a fruit-flavored liquid beverage composition
b) a cap comprising a pouch and a pouch opener;
c) a modification composition retained by the pouch;
wherein when the cap is secured onto in opening of the container containing the liquid beverage composition and when the pouch opener is activated, the modification composition is released from the pouch and mixes with the liquid beverage composition to produce a modified beverage composition having a different color and different flavor than the liquid beverage composition.

2. The beverage modification system of claim 1 wherein the liquid beverage composition comprises from about 0.01% to about 5% of a flavoring agent, by weight of the liquid beverage composition.

3. The beverage modification system of claim 2 wherein the modification composition is in a form selected from the group consisting of powder, liquids, tablets and mixtures thereof.

4. The beverage modification system of claim 3 wherein the modification composition comprises an agent selected from the group consisting of coloring agents, flavoring agents and mixtures thereof.

5. The beverage modification system of claim 4 wherein the liquid beverage composition comprises at least about 0.002% of a coloring agent, by weight of the liquid beverage composition.

6. The beverage modification system of claim 4 wherein the liquid beverage composition is cloudy.

7. The beverage modification system of claim 4 wherein the liquid beverage composition comprises from about 0.002% to about 0.1% of a coloring agent, by weight of the liquid beverage composition.

8. The beverage modification system of claim 6, wherein the pouch opener comprises a blade that cuts into and opens the pouch when the cap is twisted onto a bottle.

9. The beverage modification system of claim 6, wherein the pouch opener comprises a plunger that opens the pouch when it is pressed down and through the pouch.

10. The beverage modification system of claim 6, wherein the cap further comprises a removable retaining ring that protects the pouch from being opened prematurely.

11. The beverage modification system of claim 6 wherein the liquid beverage composition comprises from about 0.5% to about 10% fruit juice, by weight of the liquid beverage composition.

12. The beverage modification system of claim 11 wherein the modification composition comprises from about 0.1% to about 4% of a coloring agent, by weight of the composition.

13. The beverage modification system of claim 12 wherein the liquid beverage composition comprises from about 0.004% to about 0.01% of the coloring agent, by weight of the liquid beverage composition.

14. The beverage modification system of claim 13 wherein the container is an oxygen-barrier package, and is preferably a bottle.

15. The beverage modification system of claim 13 wherein the modification composition comprises from about 1% to about 15% of a flavoring agent, by weight of the composition.

16. The beverage modification system of claim 15 wherein the modification composition comprises from about 1% to about 2% of a coloring agent, by weight of the composition.

17. The beverage modification system of claim 16 wherein the ratio of the modification composition to liquid beverage composition is from about 1:1000 to about 1:10, by weight of the modified beverage composition.

18. The beverage modification system of claim 6 comprising vitamins and minerals.

19. The beverage modification system of claim 6 wherein the modification composition comprises effervescence.

20. The beverage modification system of claim 16 wherein the modification composition comprises from about 3% to about 10% of a flavoring agent, by weight of the composition.
